(19) United States
(12) Patent Application Publication
(10) Pub. No.: US 2023/0234267 A1
(43) Pub. Date: Jul. 27, 2023

(54) COMPOSITE FILM AND PRODUCTION THEREOF USING A COATING FACILITY

(71) Applicant: Klebchemie M. G. Becker GmbH & Co. KG, Weingarten/Baden (DE)

(72) Inventors: Klaus BECKER-WEIMANN, Baden-Baden (DE); Jens FANDREY, Pforzheim (DE)

(73) Assignee: Klebchemie M. G. Becker GmbH & Co. KG, Weingarten/Baden (DE)

(21) Appl. No.: 18/010,490

(22) PCT Filed: Jun. 16, 2021
(86) PCT No.: PCT/EP2021/066212

§ 371 Date: Dec. 15, 2022

(30) Foreign Application Priority Data
Jun. 16, 2020 (DE) 10 2020 115 796.7

(51) Int. Cl. B29C 41/32; B29C 41/50; B29C 41/00; B29C 41/36; B29C 41/28; B29C 35/08; B29K 75/00; B29K 105/00

(52) U.S. Cl. CPC B29C 41/32; B29C 41/50; B29C 41/003; B29C 41/36; B29C 41/28; B29C 2035/0877; B29C 2035/0827; B29K 2075/00; B29K 2105/256; B29C 2791/003

(57) ABSTRACT

The invention relates to a method for producing a composite film with a polyurethane-based reactive hot-melt layer using a coating facility, having the steps of a) optionally applying a primer onto a support material; b) applying the polyurethane-based reactive hot-melt layer onto the primer or directly onto the support material; c) applying a lacquer layer onto the polyurethane-based reactive hot-melt layer in order to produce the composite film on the support material; d) optionally embossing the composite film on the support material; and e) separating the composite film from the support material. The invention additionally relates to a composite film which can be obtained by such a method and to the use thereof.

The present invention relates to a method for producing a composite film having a polyurethane-based reactive hot-melt layer with the aid of a coating apparatus, as well as to a composite film obtainable by such a method and its use.

Plastic films manufactured on a large scale are usually produced by casting, calendering or extruding, in particular by blow molding. The materials used in this case may vary. Examples are cellulose acetate, polyvinyl chloride or polyethylene. Plastic films may be produced in one layer or multiple layers (laminated film). The machine apparatuses used for production, for example extruders, are configured for large production quantities and therefore have a comparatively expensive and complex design.

The trend toward individualization necessitates small batch sizes and minimal setup times, often in combination with the possibility of digital printing. For changing the decoration or color, the conventional methods require long setup times and generate a large loss of material due to the necessary running in. There is also a need for (laminated) films having low thermal sensitivity and/or with suitability for being usable for cladding.

Particularly in view of the lack of such apparatuses, there is a need for methods which avoid the procurement of such apparatuses and the associated disadvantages and which also represent an economical variant even for relatively small production quantities.

It is therefore an object of the present invention to provide such a method and films produced thereby.

The object is achieved by a method for producing a composite film having a polyurethane-based reactive hot-melt layer with the aid of a coating apparatus, which contains the steps

a) optionally applying a primer onto a support material;

b) applying the polyurethane-based reactive hot-melt layer onto the primer or directly onto the support material;

c) applying a lacquer layer on the polyurethane-based reactive hot-melt layer in order to produce the composite film on the support material;

d) optionally embossing the composite film on the support material;

e) separating the composite film from the support material.

The object is likewise achieved by a composite film (laminated film) which can be obtained by the method according to the invention. The composite film according to the invention is suitable, for example, as a cladding or lining material. Accordingly, a further aspect of the present invention is the use of a composite film according to the invention for cladding or for lining.

Surprisingly, it has been found that by the use of reactive hot-melts, it is possible to obtain a composite film which may be produced favorably and straightforwardly by using a coating apparatus. Thermoplastic films exhibit a certain thermal sensitivity during further processing, depending on their chemical basis and orientation. Especially during coating or adhesive bonding processes, such as hot-coating, in which the film is exposed to heat (hot-melt, lamps, drying, etc.) and/or mechanical influences (winding processes, roller compression, etc.), this may lead to folding and dimensional changes.

At the same time, films are often used in cladding processes in which a maximally high flexibility is required. Thermoplastic films which are improved in their thermal sensitivity often exhibit low flexibility. Surprisingly, it has been found that these disadvantages may be avoided or at least reduced by a composite film according to the invention with reactive hot-melts. The handling of very thermally sensitive films is obviated. The composite film produced is not thermoplastic and it nevertheless exhibits maximal flexibility.

In step a) of the method according to the invention, a primer is optionally applied on a support material. As a result of the application of the primer on the support material, a primer layer is produced on the latter. This layer may be configured in one or more layers. Accordingly, the priming step a) itself may be carried out in one or more stages.

Such priming does not, however, have to be carried out. It is however advantageous for the primer to be provided. The priming may be carried out by methods known to the person skilled in the art. Means, known to the person skilled in the art, of a coating apparatus, for example an applicator roller or slit die of the coating apparatus, are suitable in this case. Accordingly, a further aspect of the present invention is a method according to the invention, wherein the application of the primer is carried out using an applicator roller or slit die of the coating apparatus.

If a primer is provided, it may be used as a separating agent. This allows particularly straightforward separation of the composite film in step e).

It is furthermore preferred for the primer layer to be a coloring layer or an opacifying layer. If the priming is carried out in a plurality of stages and a multilayer primer layer is thus obtained, it is preferred for at least one layer of the primer to be such a coloring layer or a layer producing opacity. Accordingly, it is a further aspect of the present invention that the application of the primer forms at least one coloring layer or an opacifying layer. The primer is preferably a lacquer, in particular a UV-curing or a water-based or both a UV-curing and a water-based lacquer. The opacity is generally achieved by titanium dioxide. The primer may be optimized in its function as a decorating basis for various coloring methods, for example in respect of adhesion of pigments and ideal surface tension for wetting with printing inks.

The primer may, however, likewise be configured translucently. It is likewise possible for the primer to constitute the outer surface when using the composite film for example in cladding, so that the lacquer layer in step c) faces toward the surface of the object to be clad.

It is therefore likewise possible for the primer to be able to comprise an embossed structure. This may, for example, be produced by printing the correspondingly negative structure onto the surface of the support material with the aid of digital 3D printing, this structure then being transferred onto the primer by coating with said primer. A decoration which is matched to the embossed structure may furthermore be printed on after step b) and before step c). This matching may, for example, be carried out by data synchronization (“digitally synchronized 3D texture”). In general, embossing of this type which is suitable for decoration is referred to as “synchropore”, or the term “EIR” (embossed in register) is also used. The term “true texture” is also used in the prior art.

If priming is carried out, a reactivatable adhesive layer may be applied before its application. Such an adhesive layer may then be applied on the support surface. In this case, the adhesive layer may be used as a separating agent in order to allow releasability of the composite film.

Accordingly, it is furthermore preferred for the surface of the support material to be provided with a reactivatable adhesive layer before the application of the primer, or for this adhesive layer to be used as the primer. This is preferred in particular when a decorative layer is applied before step b).

The adhesive layer may be applied in one or more stages, and therefore may itself comprise one or more layers. It is likewise possible for the adhesive layer itself to be used as primer. The adhesive layer may be a dispersion which is reactivated by heat, for example a polyurethane dispersion. A thermoplastic hot-melt adhesive according to the prior art, which is reactivated by heat in the lining process, is preferably used. This may, for example be a hot-melt adhesive based on ethylene-vinyl acetate (EVA) copolymer, atactic polyalphaolefin (APAO), metallocene polyolefin (mPO), polyamide or polyester. It is also possible to use a reactive hot-melt adhesive based on polyurethane or polyolefin, which is reactivated by heat in a defined time window or is protected from air humidity by the support material. Further alternatives are encapsulated adhesive systems or two-component systems which are activated by heat, pressure or application of a further component in the lining process.

Before step b) of the method according to the invention, a decorative layer may be applied. This may be produced for example by direct printing or digital printing, preferably by digital printing.

In step b), a polyurethane-based reactive hot-melt layer is applied onto the primer or directly onto the support material. It is therefore directly in contact with the primer layer or the surface of the support material (support). It is, however, also possible for one or more further layers to be produced by intermediate steps, so that this layer or these layers lie(s) between the support surface and the reactive hot-melt layer. For example, a decorative layer, which is for example located between the reactive hot-melt layer and the primer, may be provided.

The reactive hot-melt layer may be applied in one coat or a plurality of coats. Accordingly, the overall reactive hot-melt layer may be single-layer or multilayer.

The reactive polyurethane hot-melt is preferably produced from isocyanate-reactive polymers and polyisocyanates, and optionally additives.

The reactive polyurethane hot-melt is a product that is solid at room temperature and is emission- and solvent-free. The temperature at which the reactive hot-melt is applied lies in a range of from 60° C. to 150° C., preferably from 100° C. to 140° C., the product having a BROOKFIELD viscosity at 120° C. in the range of from 1000 mPas to 30 000 mPas, preferably from 4000 mPas to 10 000 mPas. The density of the reactive hot-melt is usually 1.1 g/m². Advantageously, the reactive hot-melt layer itself has a certain residual elasticity in the cured state. Besides physical solidification, the curing takes place at least partially—in particular exclusively—by moisture curing, in particular with the aid of air humidity. Complete curing may take several days. The reactive hot-melt is therefore applied in the hot liquid state, and it is not necessary for complete curing to take place before the application of the lacquer layer.

Preferred isocyanate-reactive polymers are predominantly linear but also branched polyesters, in particular difunctional but also trifunctional polyethylene glycols and polypropylene glycols, polytetrahydrofurans as well as polyamides and mixtures thereof. The corresponding copolymers, in particular block copolymers, may in this case also be used.

Particularly preferred are polyester polyols, which may be liquid, vitreously amorphous or crystalline and which have a number-average molecular weight of between 400 and 25 000 g/mol, in particular between 1000 and 10 000 g/mol, particularly preferably between 2000 and 6000 g/mol. Such particularly suitable polyester polyols are available, for example, as trade products under the designation Dynacoll® from Degussa AG. Further suitable polyester polyols are polycaprolactone polyesters, polycarbonate polyester and polyester polyols based on fatty acids.

Further preferred isocyanate-reactive polymers are predominantly linear or slightly branched polyalkylene oxides, in particular polyethylene oxides, polypropylene oxides or polytetrahydrofurans (polyoxytetramethylene oxides), having a number-average molecular weight of between 250 and 12 000 g/mol, preferably having a number-average molecular weight between 500 and 4000 g/mol.

The polyisocyanate is preferably a substance or a mixture of substances selected from aromatic, aliphatic or cycloaliphatic polyisocyanates having an isocyanate functionality of between 1 and 4, preferably between 1.8 and 2.2, particularly preferably having the isocyanate functionality 2.

The polyisocyanate with a molecular mass <500 is particularly preferably a substance or a mixture of substances from the following list: methylenediphenyl diisocyanates (MDIs), in particular 4,4′-methylenediphenyl diisocyanate and 2,4′-methylenediphenyl diisocyanate as well as mixtures of different methylenediphenyl diisocyanates; hydrogenated 4,4′-MDI bis(4-isocyanatocyclohexyl)methane and hydrogenated 2,4′-MDI tetramethylxylylene diisocyanate (TMXDI); xylylene diisocyanate (XDI); 1,5-naphthalene diisocyanate (NDI); toluene diisocyanates (TDIs), in particular 2,4-toluene diisocyanate, as well as TDI-uretdiones, in particular dimeric 1-methyl-2,4-phenylene diisocyanate (TDI-U), and TDI-ureas; 1-isocyanato-3-isocyanatomethyl-3,5,5-trimethylcyclohexane (IPDI) and isomers and derivatives thereof, in particular dimers, trimers and polymers, as well as IPDI-isocyanurate (IPDI-T); 3,3′-dimethylbiphenyl-4,4′-diisocyanate (TODI); 3,3′-diisocyanato-4,4′-dimethyl-N,N′-diphenylurea (TDIH); hexamethylene-1,6-diisocyanate (HDI) and methylene-bis-(4-isocyanatocyclohexane) (H₁₂MDI).

Lightfast aliphatic polyisocyanates are preferably used.

Isocyanate-terminated prepolymers having a low residual monomer content are preferred used as polyisocyanate, in particular when prepolymers based on aliphatic isocyanates are used. Assuming they are low in monomers, that is to say their residual monomer content is no greater than 0.5 wt %, preferably less than 0.3 wt %, particularly preferably less than 0.1 wt %. In particular, reaction products of polyether polyols, preferably of polypropylene glycols, and polyester polyols with polyisocyanates, in particular methylenediphenyl diisocyanates, toluene diisocyanates, hexane diisocyanate, 3-isocyanatomethyl-3,5,5-trimethylcyclohexyl isocyanate (IPDI), hexamethylene-1,6-diisocyanate (HDI) and/or H₁₂MDI as well as the derivatives of these isocyanates are suitable. Prepolymers based on aliphatic isocyanates such as HDI and IPDI are in this case particularly preferred.

Such low-monomer isocyanate-terminated prepolymers are produced by reacting polyether polyols with an excess of polyisocyanates. After the reaction, the monomeric isocyanate still present is optionally removed by means of a thin-film evaporator.

The reactive polyurethane hot-melt may also be produced in a two-stage process according to patent specification EP1831277B2. For this purpose, the isocyanate-reactive polymers are reacted in a first step with a substoichiometric molar amount of a polyisocyanate having a molecular weight <500 g/mol, and then in a second stage the prepolymer of the first stage is reacted in a molar excess with the isocyanate-terminated prepolymers described above.

In one advantageous procedure, in order to produce the thermoplastic polyurethane, in the first method stage the isocyanate-reactive polymer or the mixture of the isocyanate-reactive polymers is freed from water at 120° C. under vacuum. It is subsequently reacted with the polyisocyanate at 80 to 140° C., preferably 100 to 120° C.

The reaction in method stages 1 and/or 2 is preferably carried out at a temperature in the range of from 80 to 140° C., in particular from 100 to 120° C.

Preferably, the reactive polyurethane composition produced in this way is subsequently put into water vapor-impermeable containers.

The reactive polyurethane hot-melt may also, according to WO 2012/084823 A1, contain abrasion-resistant fillers if an increased abrasion resistance is required during use, as is often the case in the flooring sector. Accordingly, the hot-melt may comprise an inorganic filler component, the filler component containing particles of at least one filler which have a Mohs hardness of at least 6, preferably at least 7. The particles of the at least one filler preferably have an average particle diameter in the nanoparticle range (<1 μm) or in the range of from 3.5 μm to 56 μm. The at least one filler may for example be a metal oxide, silicon dioxide, metal carbide, silicon carbide, metal nitride, silicon nitride or boron nitride. Suitable materials are corundum, emery, a spinel and/or zirconium oxide.

The reactive hot-melt may also, according to WO 2006/106143 A1, consist of a hot-melt which cures both with moisture and with UV light.

In particular, the reactive polyurethane composition may also contain auxiliaries, in particular fillers, unreactive polymers, tackifying resins, waxes, plasticizers, additives, light stabilizers, flow modifiers, accelerants, adhesion promoters, pigments, catalysts, stabilizers and/or solvents.

The unreactive polymers may preferably be polyolefins, polyacrylates, and polymers based on ethylene and vinyl acetate with vinyl acetate contents of from 0 to 80 wt %, preferably from 0.1 to 801 wt %, or polyacrylates, as well as mixtures thereof.

The reactive polyurethane composition produced in this way preferably has a viscosity of from 2000 mPas to 100 000 mPas at 120° C., preferably from 5000 to 50 000 mPas at 120° C.

Besides the reactive polyurethane hot-melt, a polyolefin-based reactive hot-melt may also be used. The latter cures via the reaction of silane groups with air humidity.

Preferably, the reactive hot-melt layer is a moisture-curing layer. It is furthermore preferred for it to be a reactive polyurethane hot-melt (PUR-SK), which may preferably be obtained from isocyanate-reactive polymers and polyisocyanates as well as optionally additives. In particular, a lightfast PUR-SK as described above is preferred.

The reactive hot-melt may comprise additives, for example fillers, in particular abrasion-resistant fillers, as described above. The inorganic filler component preferably comprises a proportion in the range of from 5 wt % to 60 wt %, based on the total weight of the reactive hot-melt. Furthermore preferably, the proportion lies in the range of from 10 wt % to 50 wt %, even more preferably in the range of from 15 wt % to 30 wt %.

Preferably, the reactive hot-melt layer has a thickness in the range of from 20 μm to 150 μm.

The application of the reactive hot-melt layer may be applied by methods known to the person skilled in the art. Means of the coating apparatus which are suitable for producing a reactive hot-melt layer are known.

Preferably, the application of the reactive hot-melt layer is carried out using an applicator roller with or without a smoothing roller or a slit die with or without a roll bar of the coating apparatus.

In step c) of the method according to the invention, a lacquer layer is applied. By applying the lacquer layer on the polyurethane-based reactive hot-melt layer, the composite film may be produced on the support material. The lacquer layer may be applied in one or more stages.

Accordingly, a single-layer or multilayer structure of the lacquer layer is possible. Preferably, however, the lacquer layer is applied in a single coat. In particular, it is preferred for the hot-melt layer and the lacquer layer each to be applied as a single coat.

Preferably, the lacquer layer has a thickness of from 5 μm to 25 μm.

The lacquer has a flexibility that is required for roll materials. It can significantly determine the gloss level of the composite film. It may be optimized for physical matting (excimer)—including explicit high-gloss properties (flow properties, suitability for inert calendering methods (ICC)). At the same time, embossing of the lacquer layer or of the entire composite film may be carried out by ICC technology.

The lacquer may be adapted in such a way that it has chemical-physical properties as a function of the field of application of the composite film (scratch resistance, outdoor weathering, or the like). Such lacquers are known in the prior art.

The lacquer is preferably a lacquer which can be crosslinked by means of electron radiation or UV radiation.

As components that can be polymerized by irradiation, all compounds which preferably contain one or more functional groups polymerizable by electron and/or UV radiation may in this case be used. Preferably, compounds having olefinically unsaturated functional groups are used in this case.

Examples of such compounds are styrene, 1-methylstyrene, vinyl acetate, vinyl chloride, conjugated dienes such as butadiene and isoprene, vinyl ethers of C1-C20 alkanols, but also arylnitrile, vinylcaprolactam, n-vinyl formamide, C1-C4 acrylates and methacrylates such as methyl (meth)acrylate, ethyl (meth)acrylate, n-propyl (meth)acrylate, isobornyl acrylate (IBOA), and the like. Furthermore, higher-functional components such as trimethylol triacrylate (TMTPA), ethoxylated trimethylol triacrylate, propoxylated glycerol diacrylate, butandiol diacrylate (BDDA), hexandiol diarylate (HDDA), tripropylene glycol diacrylate (TPGDA), dipropylene glycol diacrylate (DPGDA), pentaerythritol triacrylate (PETIA) and pentaerythritol tetraacrylate (PETTA) may also be used.

Besides these, so-called oligomers may also be used. Oligomers are intended to mean, for example, aliphatic and aromatic epoxy acrylates, aliphatic and aromatic urethane acrylates, polyester acrylates, polyether acrylates and amine-functionalized polyether acrylates as well as unsaturated polyester resins.

These oligomers are known from the prior art and are obtainable, for example, from the company Rahn under the brand name Genomer®, the company Allnex under the brand name Ebecryl®, the company Miwon under the brand name Miramer®, the company Sartomer under the CN range, or the company BASF under the brand name Laromer 1®.

Preferably, as a photoinitiator for the radical reaction, substances and substance mixtures which are capable of initiating a radical polymerization of olefinically unsaturated double bonds when irradiated with light having a wavelength of from about 240 to about 480 nm may be used. Suitable photoinitiators are described, for example, in Advances in Polymer Science, Volume 14, Springer Berlin 1974.

For example, these are all Norrish Type I fragmenting substances. Examples thereof are benzophenone, camphorquinone, Quantacure (manufacturer: International Bio-Synthetics), photoinitiators of the Omnirad® range (company IGM), the Genocure® range (company Rahn) and the Speedcure TM® range (manufacturer Lambson).

Particularly suitable photoinitiators are those from the class of benzoins, phenylhydroxyalkonones, alpha-hydroxyketones, alpha-aminoketones, phenylglyoxilates, monoacyl phosphines (MAPO) and bisacyl phosphines (BAPO).

Particularly suitable examples of photoinitiators are Speedcore 73, Ominirad 819, Speedcure MBF and Ominirad TPO.

Also particularly suitable are polymerizable photoinitiators, such as are available for example from the company Rahn under the brand name Genopol®.

The lacquer may be transparent or pigmented. If the lacquer is pigmented, it preferably contains titanium dioxide as a filler. The lacquer may however also contain other fillers, for example chalk, talc as well as fillers to increase the scratch and microscratch resistance, for example glass beads or nanoparticles. Furthermore, the lacquer may also contain color pigments.

The lacquer may furthermore also contain additives conventional for lacquers, which are known to the person skilled in the art, such as antifoaming agents, deaerators, surfactants, dispersants, flow modifiers, antioxidants and UV stabilizers, etc.

The lacquer preferably has a Brookfield viscosity (20° C.) of 200 mPas-20 000 mPas, preferably 500 mPas-10 000 mPas.

If priming (step a) is carried out and a lacquer is used for this, it may likewise have the properties mentioned above.

The support material may be a metal foil, a CPL laminate (continuous pressure laminate), melamine paper, separating paper, silicone-coated web material or a plastic film, or may contain at least one of these materials or a plurality thereof. In particular, a plastic film is preferred. In the selection of the support material, high dimensional stability and mechanical strength under thermal loading are advantageous. The separability of the primer or of the reactive hot-melt layer may also be taken into account in the selection of the support material.

Preferably, the support material has a thickness of from 30 μm to 400 μm. It is, however, also possible for the support material to be a conveyor belt of the coating apparatus.

The support material may simultaneously be a support of printing inks which are introduced into the reactive hot-melt layer by the transfer printing method (sublimation).

Furthermore, the embossing of the composite film on the support material may be provided as step d). Such a step may, however, likewise be omitted. The embossing may be carried out by an embossing roller of the coating apparatus or structuring web material which is pressed on.

In step e), the composite film is separated from the support material. Preferably, the separation of the composite film from the support material is carried out by peeling after crystallization or full reaction of the reactive hot-melt layer. Preferably, the support material may be reused in the method according to the invention after the separation in step e), optionally after cleaning. Accordingly, it is preferred for the support material to be reused for the according to the invention.

Preferably, the coating apparatus is a roll-to-roll apparatus. The term roll-to-roll apparatus is to be understood as a processing apparatus in which roll material, in the scope of the present invention the support material, is fed into the apparatus and the desired product, that is to say in the scope of the present invention the composite film, is likewise obtained as a roll after processing.

Both the composite film and the support material are preferably further obtained in the form of a roll. The materials may be wound onto replaceable sleeves accurately by means of edge control, so that they may be processed further in lining processes by holders which are conventional on the market.

In a preferred embodiment, accordingly, after the separation in step e) of the method according to the invention, the composite film according to the invention is obtained as a roll which may be obtained by winding. It is likewise preferred for the support to be in the form of a roll before step a), which is unwound for the processing of the support in the coating apparatus.

The method according to the invention may contain further steps. For example, smoothing of the reactive hot-melt layer after step b) and before step c) is possible. At least one of the following steps is also possible:
physical matting of the lacquer (excimer lamp)
smoothing and curing of the lacquer by means of an inert calender method
division of the composite film obtained into different widths may be carried out by means of a downstream cutting device (for example with roll blades).
sprinkling of particles after the application of the reactive hot-melt layer in order to produce an “antislip” surface.

The composite film according to the invention may, for example, be used for cladding or for lining. In this case, the composite film may be provided with an adhesive layer beforehand. Suitable adhesives are for example hot-melt adhesives, which may be thermoplastic or reactive, in particular PUR-SK, dispersions and hot-melt pressure-sensitive adhesives. Application is possible, for example, by means of rollers or slit dies.

The composite film produced may be used as a replacement for conventional films. A field of application could be for flooring. In this case, in particular, replacement of TPU, PET or PVC films would be possible.

Outdoor applications are also conceivable, in particular as a replacement for PMMA films, for example as window films, for frontages or for profiled sections. Further application possibilities are patio surfaces and furniture, particularly in order to produce a soft touch and with textures.

The invention will be explained in more detail with the aid of the following figure and examples, without the present invention being restricted thereto.

### EXAMPLES

Example 1 Flooring Film: highly abrasion-resistant, splitting-resistant, adhesive bonding and embossing by means of reactivation

An exemplary composite film according to the invention has the following layer structure:
1. thermally reactivatable adhesive, opaque (for example EVA SK Kleiberit 743.6)
2. primer: opaque, white, UV-curing (for example UV lacquer Kleiberit 653.1.33)
3. digital printing: UV-curing printing inks, applied using a single-pass printer
4. polyurethane-based reactive hot-melt layer with corundum (for example PUR HotCoating Kleiberit 717.6)
5. acrylic lacquer UV-curing: scratch-resistant, optionally physically matted (for example UV lacquer Kleiberit 659.0.04)

Further processing may be carried out: short-cycle pressing or lining apparatuses with a heated calender roller, introduction of textures by means of pressing plates/matrices or embossing rollers.

Example 2 Patio Floor Film: highly abrasion-resistant, splitting-resistant, weathering-resistant

An exemplary composite film according to the invention has the following layer structure:
1. primer: opaque, white, UV-curing, optimized wetting behavior (for example UV lacquer Kleiberit 653.1.33)
2. digital printing: UV-curing printing inks, applied using a single-pass printer
3. polyurethane-based reactive hot-melt layer containing corundum with UV absorbers (for example PUR HotCoating Kleiberit 9383/627)
4. acrylic lacquer UV-curing: scratch-resistant, weathering-resistant, flexible (for example UV lacquer Kleiberit 659.2.22)
5. embossing/antislip surface

Further processing may be carried out: cladding apparatus with PUR hot-melt adhesive.

In the figure:

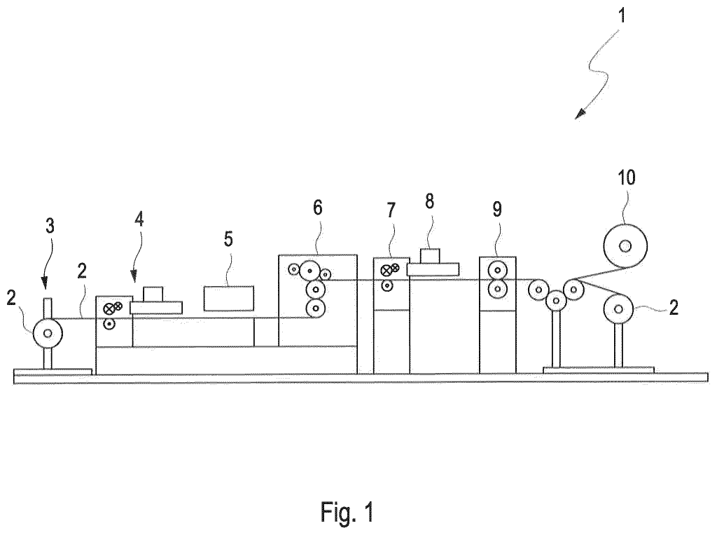

FIG. 1 shows a coating apparatus for producing composite films according to the invention

In the coating apparatus 1, a support film 2 as support material is delivered from a roll unit 3 to a priming unit 4, in which the support film 2 is primed and optionally provided with reactivatable adhesive on the surface of the support film. The support film 2 subsequently passes through a printing unit 5, which makes it possible to print on the primed support film surface. The support film surface is then coated with a polyurethane-based reactive hot-melt in a subsequent coating unit 6. A UV lacquer layer is then applied in a lacquering unit 7. The curing unit 8 in the form of a UV lamp cures the UV lacquer. Embossing is subsequently carried out in an embossing unit 9, followed by the separation and winding of the support film 2 and of the composite film 10 according to the invention.

### LIST OF REFERENCES

1 coating apparatus

2 support film

3 roll unit

4 priming unit

5 printing unit

6 coating unit

7 lacquering unit

8 curing unit

9 embossing unit

10 composite film

1. A method for producing a composite film having a polyurethane-based reactive hot-melt layer with the aid of a coating apparatus, which contains the steps
a) optionally applying a primer onto a support material;
b) applying the polyurethane-based reactive hot-melt layer onto the primer or directly onto the support material;
c) applying a lacquer layer on the polyurethane-based reactive hot-melt layer in order to produce the composite film on the support material;
d) optionally embossing the composite film on the support material;
e) separating the composite film from the support material.

2. The method as claimed in claim 1, characterized in that the primer is provided.

3. The method as claimed in claim 1, characterized in that the primer is used as a separating agent.

4. The method as claimed in claim 1, characterized in that the hot-melt layer and the lacquer layer are each applied in one coat.

5. The method as claimed in claim 1, characterized in that the reactive hot-melt layer has a thickness in the range of from 20 μm to 150 μm.

6. The method as claimed in claim 1, characterized in that the lacquer layer has a thickness in the range of from 5 μm to 25 μm.

7. The method as claimed in claim 1, characterized in that the application of the primer forms at least one coloring layer or an opacifying layer and is preferably a lacquer, in particular a UV-curing or a water-based or both a UV-curing and a water-based lacquer.

8. The method as claimed in claim 1, characterized in that the surface of the support material is provided with a reactivatable adhesive layer before the application of the primer, or this adhesive layer is used as the primer.

9. The method as claimed in claim 1, characterized in that a decorative layer is produced before step b), preferably by digital printing.

10. The method as claimed in claim 1, characterized in that the application of the primer is carried out using an applicator roller or slit die of the coating apparatus.

11. The method as claimed in claim 1, characterized in that the primer comprises an embossed structure and a decoration which is matched to the embossed structure is printed on, preferably after step b) and before step c).

12. The method as claimed in claim 1, characterized in that the support material is or at least contains a metal foil, a CPL laminate, melamine paper, separating paper, silicone-coated web material or a plastic film, in particular a plastic film.

13. The method as claimed in claim 1, characterized in that the support material has a thickness of from 30 μm to 400 μm.

14. The method as claimed in claim 1, characterized in that the support material is a conveyor belt of the coating apparatus.

15. The method as claimed in claim 1, characterized in that the application of the reactive hot-melt layer is carried out using an applicator roller with or without a smoothing roller or a slit die with or without a roll bar of the coating apparatus.

16. The method as claimed in claim 1, characterized in that the reactive hot-melt layer is a moisture-curing layer.

17. The method as claimed in claim 1, characterized in that the reactive hot-melt layer is a reactive polyurethane hot-melt, which is preferably obtainable from isocyanate-reactive polymers and polyisocyanates, and optionally additives.

18. The method as claimed in 17 claim 1, characterized in that the embossing of the composite film is provided.

19. The method as claimed in claim 1, characterized in that the embossing is carried out using an embossing roller of the coating apparatus.

20. The method as claimed in claim 1, characterized in that the separation of the composite film from the support material is carried out by peeling after crystallization or full reaction of the reactive hot-melt layer.

21. The method as claimed in claim 1, characterized in that the reactive hot-melt layer contains at least one filler, in particular an abrasion-resistant filler.

22. The method as claimed in claim 1, characterized in that the coating apparatus is a roll-to-roll apparatus.

23. The method as claimed in claim 1, characterized in that the lacquer of the lacquer layer in step c) can be crosslinked by means of electron radiation or UV radiation.

24. The method as claimed in claim 1, characterized in that the support material is reused for the method.

25. A composite film obtainable by a method as claimed in claim 1.

26. (canceled)
